(19) United States
(12) Patent Application Publication
(10) Pub. No.: US 2024/0219417 A1
(43) Pub. Date: Jul. 4, 2024

(54) SPEED MEASUREMENT METHOD, SYSTEM, AND APPARATUS OF MEDIUM AND LOW SPEED MAGLEV TRAIN

(71) Applicants: CRSC RESEARCH & DESIGN INSTITUTE GROUP CO.,LTD., Beijing (CN); EAST CHINA JIAOTONG UNIVERSITY, Nanchang City (CN)

(72) Inventors: Ling LIU, Beijing (CN); Hui YANG, Nanchang City (CN); Junfeng CUI, Beijing (CN); Yanli ZHOU, Nanchang City (CN); Jing SHI, Beijing (CN); Shuaiqiang DONG, Nanchang City (CN); Jia LIU, Nanchang City (CN); Yating FU, Nanchang City (CN); Zhongqi LI, Nanchang City (CN)

(73) Assignees: CRSC RESEARCH & DESIGN INSTITUTE GROUP CO.,LTD., Beijing (CN); EAST CHINA JIAOTONG UNIVERSITY, Nanchang City (CN)

(21) Appl. No.: 18/212,067

(22) Filed: Jun. 20, 2023

(30) Foreign Application Priority Data
Dec. 26, 2022 (CN) 202211670146.8

(51) Int. Cl. G01P 3/50; G01S 13/60

(52) U.S. Cl. CPC G01P 3/505; G01S 13/60; B60L 13/04

(57) ABSTRACT

A speed measurement method, system and apparatus of a medium and low speed maglev train are provided. The method comprises: determining a position of a marked eddy current sensor for each eddy current pulse of each of two eddy current pulse data groups based on the eddy current pulse, distribution data of maglev steel rail sleepers and eddy current sensors; determining a first speed value based on positions of marked eddy current sensors and pulse moments respectively corresponding to two adjacent eddy current pulses; calculating a second speed value based on a first speed value corresponding to an eddy current pulse data group of which pulse moment is ranked ahead in the two eddy current pulse data groups and an acceleration sensing data; calculating a third speed value based on radar sensing data; and fusing the first, second and third speed values to obtain a final speed value.

### CROSS REFERENCE TO RELATED APPLICATION

This disclosure claims the benefit and priority of Chinese Patent Application No. 202211670146.8 filed with the China National Intellectual Property Administration (CNIPA) on Dec. 26, 2022, the disclosure of which is incorporated by reference herein in its entirety as part of the present disclosure.

### TECHNICAL FIELD

This disclosure relates to the technical field of speed measurement of a maglev train, and in particular, to a speed measurement method, system, and apparatus of a medium and low speed maglev train using sensors and distribution information of steel rail sleepers.

### BACKGROUND

With the rapid and further development of the maglev technologies and studies, the maglev train becomes quite popular in our daily life. Because the maglev train does not have wheels, a common speed measurement and positioning system based on a rotation speed of the wheel is obviously not suitable for the maglev train. Therefore, in academic, it has become a new research hotspot in the maglev train field to develop a speed measurement and positioning system for the maglev train and improve the intelligent driving system of the maglev train.

At present, the speed measurement and positioning of the maglev train is mainly achieved based on fusion of information of various non-contact sensors, which are commonly eddy current speed measurement sensors. The eddy current speed measurement sensor works based on a pulse signal generated when the sensor passes a steel rail sleeper. That is, speed measurement may be achieved only when more than one sensor signals are collected, which are generated by different sensors passing a same rail sleeper. This speed measurement method functions smoothly when the maglev train runs at a high speed. However, for the medium and low speed maglev train, especially in a low speed running section of the train, a pulse speed measurement period corresponding to this section is long. Therefore, a speed measurement result is not accurate enough.

### SUMMARY

An objective of this disclosure is to provide a speed measurement method, system, and apparatus of a medium and low speed maglev train. This method, system, and apparatus can implement positioning and speed measurement at the same time and improve speed measurement accuracy.

To achieve the above objective, this disclosure provides the following technical solutions.

A speed measurement method of a medium and low speed maglev train is provided, which includes:
acquiring two eddy current pulse data groups of the maglev train, where each of the two eddy current pulse data groups includes two adjacent eddy current pulses;
determining, for each eddy current pulse in each eddy current pulse data group, a position of a marked eddy current sensor based on the eddy current pulse, distribution data of maglev steel rail sleepers, and distribution data of eddy current sensors of the maglev train, where the marked eddy current sensor is any eddy current sensor in the maglev train;
determining a first speed value of the maglev train based on positions of marked eddy current sensors respectively corresponding to the two adjacent eddy current pulses and pulse moments respectively corresponding to the two adjacent eddy current pulses;
calculating a second speed value of the maglev train based on a first speed value corresponding to an eddy current pulse data group of which pulse moment is ranked ahead in the two eddy current pulse data groups and in combination with acceleration sensing data;
calculating a third speed value of the maglev train based on radar sensing data: and
fusing the first speed value, the second speed value, and the third speed value to obtain a final speed value of the maglev train.

In some embodiments, the distribution data of the maglev steel rail sleepers includes sleeper number data and sleeper spacing data. The distribution data of the eddy current sensors of the maglev train includes sensor number data and sensor spacing data.

The determining, for each eddy current pulse in each eddy current pulse data group, a position of a marked eddy current sensor based on the eddy current pulse, distribution data of maglev steel rail sleepers, and distribution data of eddy current sensors of the maglev train specifically includes:
determining, based on the eddy current pulse, the sleeper number data, and the sensor number data, a sleeper number and a sensor number corresponding to the eddy current pulse: and
determining the position of the marked eddy current sensor based on the sleeper spacing data, the sensor spacing data, a sensor number corresponding to the marked eddy current sensor, and the sleeper number and the sensor number corresponding to the eddy current pulse.

In some embodiments, the determining a first speed value of the maglev train based on positions of marked eddy current sensors respectively corresponding to the two adjacent eddy current pulses and pulse moments respectively corresponding to the two adjacent eddy current pulses specifically includes:
calculating a moving distance value of the maglev train based on the positions of marked eddy current sensors respectively corresponding to the two adjacent eddy current pulses;
calculating a moving time difference of the maglev train based on the pulse moments respectively corresponding to the two adjacent eddy current pulses; and
calculating the first speed value of the maglev train based on the moving distance value of the maglev train and the moving time difference of the maglev train.

In some embodiments, the calculating a second speed value of the maglev train based on a first speed value corresponding to an eddy current pulse data group of which pulse moments is ranked ahead in the two eddy current pulse data groups and in combination with acceleration sensing data specifically includes:
calculating the second speed value of the maglev train according to the following formula

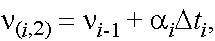

where
v_{(i,2)} represents the second speed value of the maglev train: vᵢ₋₁ represents the first speed value corresponding to an eddy current pulse data group of which pulse moment is ranked ahead in the two eddy current pulse data groups; aᵢ represents an acceleration value; Δtᵢ represents a difference between pulse moment respectively corresponding to the two eddy current pulse data groups; and i represents a sequence of the eddy current pulse data group in the two eddy current pulse data groups.

In some embodiments, the radar sensing data includes a frequency shift measured by a Doppler radar, an included angle between a radar sensor and a rail plane of the maglev train, and a radar wavelength.

The calculating a third speed value of the maglev train based on radar sensing data specifically includes:
calculating the third speed value of the maglev train according to the following formula

$${v}_{( i , 3 )} = \frac{{f}_{i} \cdot λ}{2 cos θ} ,$$

where
v_{(i,3)} represents the third speed value of the maglev train; fᵢ represents a frequency shift measured by a Doppler radar corresponding to an eddy current pulse data group of which pulse moment is ranked behind in the two eddy current pulse data groups; λ represents the radar wavelength; and θ represents the included angle between a radar sensor and a rail plane of the maglev train.

In some embodiments, the fusing the first speed value, the second speed value, and the third speed value to obtain a final speed value of the maglev train specifically includes:
calculating a difference between the first speed value and the second speed value, a difference between the second speed value and the third speed value, and a difference between the third speed value and the first speed value, and calculating absolute values thereof to obtain three difference values;
if the three difference values are all smaller than a preset error value, calculating an average of the first speed value, the second speed value, and the third speed value, to obtain the final speed value of the maglev train; or
if any two of the three difference values are larger than the preset error value, calculating an average of two speed values corresponding to an other difference value than the any two difference values, to obtain the final speed value of the maglev train.

In some embodiments, the speed measurement method further includes:
acquiring an actual number of each maglev steel rail sleeper through an on-board code reader;
acquiring, by using an eddy current sensor located at a head of the maglev train, a number of times that the train crosses the sleeper;
determining, based on the number of times that the train crosses the sleeper, a calculated number corresponding to the maglev steel rail sleeper which is read by the on-board code reader;
comparing the calculated number with the actual number to obtain a first result; and
if the first result indicates that the calculated number and the actual number are not consistent, generating a missing detection warning signal; or
if the first result indicates that the calculated number and the actual number are consistent, generating a data normal signal.

To achieve the above objective, this disclosure further provides the following technical solutions.

A speed measurement system of a medium and low speed maglev train is also provided, which includes:
a pulse data acquisition module, configured to acquire two eddy current pulse data groups of the maglev train, where each of the two eddy current pulse data groups includes two adjacent eddy current pulses;
a sensor position determining module, configured to determine, for each eddy current pulse in each eddy current pulse data group, a position of a marked eddy current sensor based on the eddy current pulse, distribution data of maglev steel rail sleepers, and distribution data of eddy current sensors of the maglev train, where the marked eddy current sensor is any eddy current sensor in the maglev train;
a first speed calculation module, configured to determine a first speed value of the maglev train based on positions of marked eddy current sensors respectively corresponding to the two adjacent eddy current pulses and pulse moments respectively corresponding to the two adjacent eddy current pulses;
a second speed calculation module, configured to calculate a second speed value of the maglev train based on a first speed value corresponding to an eddy current pulse data group of which pulse moment is ranked ahead in the two eddy current pulse data groups and in combination with acceleration sensing data;
a third speed calculation module, configured to calculate a third speed value of the maglev train based on radar sensing data; and
a final speed calculation module, configured to fuse the first speed value, the second speed value, and the third speed value to obtain a final speed value of the maglev train.

A speed measurement apparatus of a medium and low speed maglev train is further provided, which includes a memory and a processor.

The memory is configured to store a computer program. The processor is configured to run the computer program to perform the speed measurement method of the medium and low speed maglev train.

According to specific embodiments of this disclosure, the following technical effect is disclosed.

According to the speed measurement method, system, and apparatus of a medium and low speed maglev train provided by this disclosure, two adjacent eddy current pulses are acquired. For each eddy current pulse, a position of any of eddy current sensors of the maglev train is determined based on the eddy current pulse, the distribution data of the maglev steel rail sleepers, and the distribution data of the eddy current sensors of the maglev train, and adopted as a positioning reference. Similarly, for adjacent eddy current pulses, a position of the positioning reference in this eddy current pulse is determined based on the distribution data of the maglev steel rail sleepers and the distribution data of the eddy current sensors of the maglev train. The first speed value of maglev train is determined based on a change between positions of the same eddy current sensor in the adjacent eddy current pulses. The distribution information of the sleeper belongs to an absolute positioning mode. When the speed is measured based on the distribution information of the sleepers, the position of the maglev train may be directly updated while the speed is measured, so that a positioning requirement of the maglev train can be met. According to adjacent two eddy current pulses of the other group, the second speed value is calculated based on the acceleration sensing data. A third speed value is calculated based on the radar sensing data. Finally, a high accurate final speed value of the maglev train is calculated by fusing the first speed value, the second speed value and the third speed value.

To sum up, a new speed measurement method is provided based on the distribution data of the maglev steel rail sleepers and the distribution data of the eddy current sensors of the maglev train according to the disclosure, which may calculate the speed in real time based on the two adjacent pulses.

### BRIEF DESCRIPTION OF THE DRAWINGS

To describe the technical solutions in the embodiments of this disclosure or in the prior art more clearly, the accompanying drawings required in the embodiments are briefly described below. Apparently, the accompanying drawings in the following description show merely some embodiments of this disclosure, and other drawings can be derived from these accompanying drawings by those of ordinary skill in the art without creative efforts.

FIG. 1 is a schematic flowchart of speed measurement method of a medium and low speed maglev train according to this disclosure;

FIG. 2 is a schematic diagram of distribution of steel rail sleepers and eddy current sensors according to this disclosure:

FIG. 3 is a diagram of comparison between two theoretical speed measurements according to this disclosure; and

FIG. 4 is a schematic diagram of a structure of a speed measurement system of a medium and low speed maglev train according to this disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

This disclosure provides a speed measurement method, system, and apparatus of a medium and low speed maglev train, which measure a speed of the maglev train by means of a plurality of sensors and based on distribution information of sleepers. Specifically, distribution of steel rail sleepers in a sensor section is updated, and then a distance value between each sensor and a sleeper through which the sensor is to pass is updated. When a pulse comes, the speed may be measured through reading time information of a previous pulse. Thus, a time interval of a speed measurement is shorten, so that a speed measurement result may be obtained in real time.

To make the above objectives, features, and advantages of this disclosure clearer and more comprehensible, this disclosure will be further described in detail below with reference to the accompanying drawings and specific implementations.

### Embodiment 1

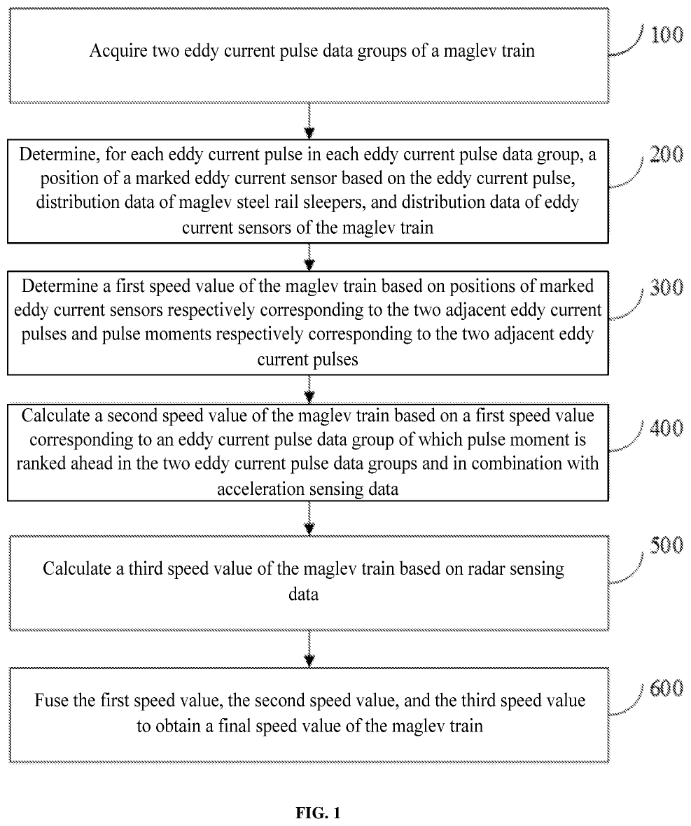

Refer to FIG. 1, a speed measurement method of a medium and low speed maglev train is provided by this embodiment, which includes the following steps 100 to 200.

In Step 100, two eddy current pulse data groups of the maglev train are acquired, where each of the two eddy current pulse data groups includes two adjacent eddy current pulses.

In Step 200, for each eddy current pulse in the eddy current pulse data group, a position of a marked eddy current sensor is determined based on the eddy current pulse, distribution data of maglev steel rail sleepers, and distribution data of eddy current sensors in the maglev train, where the marked eddy current sensor is any eddy current sensor in the maglev train.

Specifically, the distribution data of the maglev steel rail sleepers includes sleeper number data and sleeper spacing data. The distribution data of the eddy current sensors in the maglev train includes sensor number data and sensor spacing data. A process of obtaining the distribution data of the maglev steel rail sleepers is as follows:
a running line of the maglev train is determined based on historical running data of the maglev train, and distribution data of steel rail sleepers on the running line of the maglev train is determined based on laying construction data of the maglev steel rail sleepers.

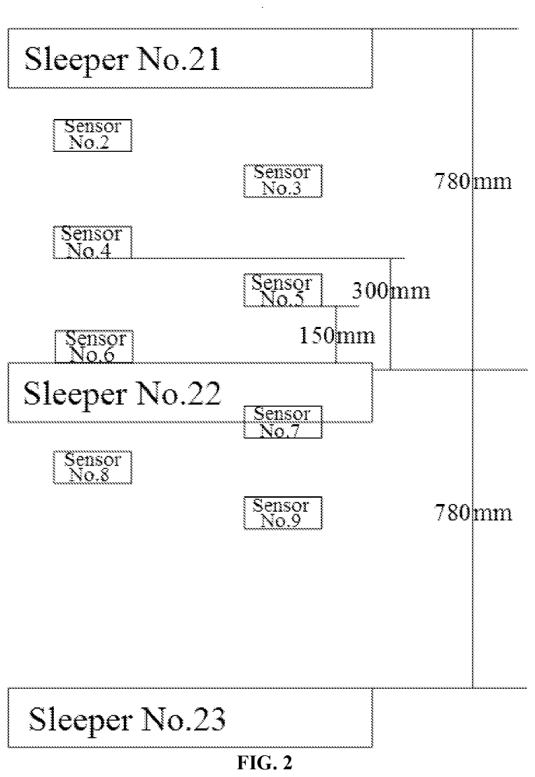

Referring to FIG. 2, a sleeper spacing between any two adjacent steel rail sleepers is 780 mm, and a sensor spacing between any two adjacent sensors is 150 mm.

To facilitate calculation, a distance value between two adjacent steel rail sleepers at joints of different steel rails in a maglev train track, a number of steel rail sleepers and a spacing between the sleepers after each steel rail is produced are used to create a distribution database of the steel rail sleepers in the running line of the maglev train. In a subsequent calculation, data in the distribution database of the steel rail sleepers may be directly used.

To facilitate further calculation and reduce data retrieval time during the calculation, each steel rail sleeper is numbered to obtain the sleeper number data. A sleeper number of each sleeper is associated with a distance value between the steel rail sleeper and a front steel rail sleeper and a distance value between the steel rail sleeper and a rear steel rail sleeper.

In a specific actual application, the speed measurement method of a medium and low speed maglev train further includes a step of detecting whether the steel rail sleeper number is not detected. This step specifically includes the following steps 1) to 4).

In step 1), an actual number of the maglev steel rail sleeper is acquired through an on-board code reader. Specifically, the actual number of the maglev steel rail sleeper is acquired through a U-shaped reader installed at a bottom of the maglev train.

In step 2), a number of times that the train crosses the sleepers is obtained through an eddy current sensor located at a head of the maglev train. When the eddy current sensor located at a head of the maglev train generates a pulse signal, it indicates that the train is crossing a new sleeper, and the number of times that the train crosses the sleepers is increased by one. Based on the same principle, an eddy current sensor located at a middle or a tail of the maglev train may obtain a number of times that each eddy current sensor crosses the sleepers, based on generated pulse signals.

In step 3), a calculated number corresponding to the maglev steel rail sleeper which is read by the on-board code reader, is determined based on the number of times that the train crosses the sleepers.

In step 4), the calculated number is compared with an actual number to obtain a first result. If the first result indicates that the calculated number and the actual number are not consistent, a missing detection warning signal is generated. If the first result indicates that the calculated number and the actual number are consistent, a data normal signal is generated, to indicate that there is no missing detection.

It is worth mentioning that, in an actual operation of the maglev train, a plurality of eddy current sensors are installed at the bottom of the maglev train, and a distance between a first sensor and the last sensor is greater than a spacing between two adjacent sleepers, pulse signals received by the maglev train do not completely follow an installation sequence of the sensors, that is, there is a problem that the pulses are out-of-order. In addition, when the speed of the maglev train is calculated, a pulse signal of a previous sensor that passes a same sleeper needs to be found. Therefore, the most front pulse signal may only be used to measure the speed by a rear sensor, and the most front sensor can not obtain a speed measurement value by itself. In view of this, this disclosure provides two solutions.

(1) A set of serial numbers of sensors is established. When a pulse signal of a corresponding sensor is collected, it is used to update pulse information and calculate a time difference with a pulse signal of a sensor with a previous serial number, so as to calculate a speed measurement value based on the spacing between the corresponding sensor and the sensor with the previous serial number. (2) A distance between each sensor and a sleeper through which the sensor is to pass is updated in real time, based on distribution information of sleepers and distribution information of sensors, and the speed measurement value is calculated based on a time interval that pulses arrive in sequence.

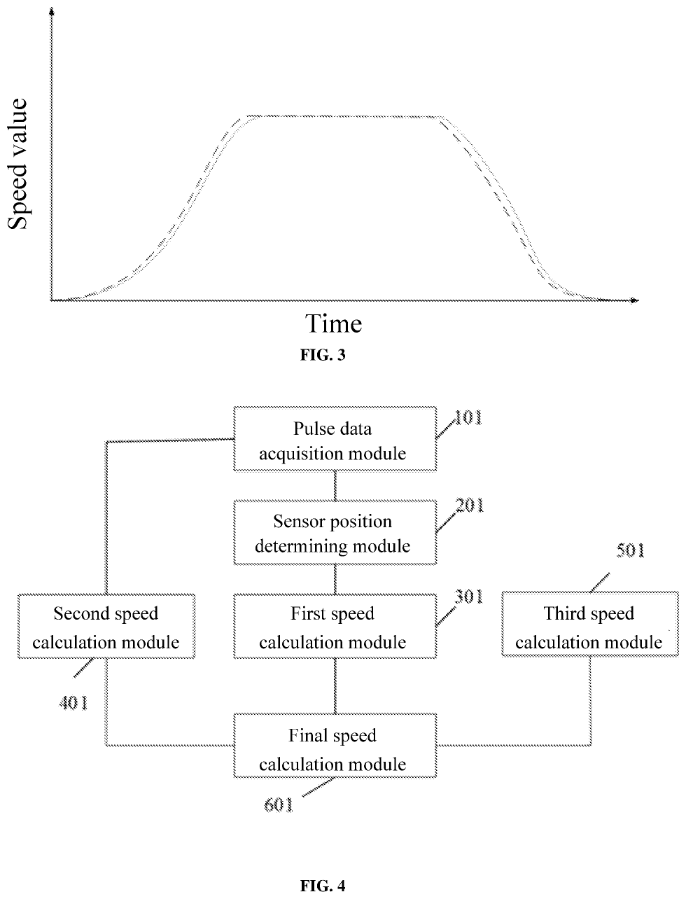

In the two solutions, for the former solution, since the most front sensor cannot find information of a previous pulse caused by passing the same sleeper, the speed measurement value calculated by the most front sensor is not credible and can only be predicted by fitting other data. In the latter solution, since the distance between each sensor and a sleeper that the sensor is to pass is updated in real time, there is no such problem. FIG. 3 is a theoretical diagram of a correspondence between a speed measurement value and time when a speed is measured by the two solutions, in which a solid line corresponds to a speed measurement value of the solution (1), and a dotted line corresponds to a speed measurement value of the solution (2).

Based on the foregoing solution (2), the step 200 specifically includes the following steps 1) and 2).

In step 1), a sleeper number and a sensor number corresponding to an eddy current pulse are determined based on the eddy current pulse, the sleeper number data, and the sensor number data.

In step 2), the position of the marked eddy current sensor is determined based on the sleeper spacing data, the sensor spacing data, a sensor number corresponding to the marked eddy current sensor, and the sleeper number and the sensor number corresponding to the eddy current pulse.

The step 200 is specifically described as follows.

When an eddy current pulse ends (that is, when a falling edge of the eddy current pulse comes), a sensor number corresponding to the eddy current pulse (that is, a number of an eddy current sensor sending the eddy current pulse) is detected; and a sleeper number of a steel rail sleeper corresponding to the eddy current pulse is detected through the U-shaped reader. With FIG. 2 as an example, assuming that when the eddy current pulse ends, the number of the eddy current sensor sending the eddy current pulse is 6 and the number of the corresponding sleeper is 22, and according to a known sleeper spacing between two adjacent steel rail sleepers of 780 mm and the sensor spacing between two adjacent sensors of 150 mm, it can be deduced and calculated that:
a distance between a sensor numbered 5 and a sleeper (numbered 21) through which the sensor is to pass is 630 mm, a distance between a sensor numbered 6 and the sleeper (numbered 21) through which the sensor is to pass is 780 mm, and a distance between a sensor numbered 7 and a sleeper (numbered 22) that the sensor is to pass is 150 mm.

Generally, to facilitate calculation, the eddy current sensor numbered 6 and sending an eddy current pulse can be used as the marked eddy current sensor, the marked eddy current sensor is located at 780 mm away from the sleeper (numbered 21) through which the sensor is to pass.

If a sensor numbered 4 is used as the marked eddy current sensor, based on the fact that the known sleeper spacing between two adjacent steel rail sleepers is 780 mm, the sensor spacing between two adjacent sensors is 150 mm, and the distance between a sensor numbered 6 and the sleeper numbered 21 through which the sensor is to pass is 780 mm, it can be deduced and calculated that the marking eddy current sensor is located at 480 mm away from the sleeper 21 through which the sensor is to pass.

In step 300, a first speed value of the maglev train is determined based on positions of marked eddy current sensors respectively corresponding to the two adjacent eddy current pulses and pulse moments respectively corresponding to the two adjacent eddy current pulses.

The step 300 specifically includes the following steps 1) to 3).

In step 1), a moving distance value of the maglev train is calculated based on the positions of marked eddy current sensors respectively corresponding to the two adjacent eddy current pulses. That is, when one pulse ends, measurement information of each eddy current sensor and a distance between the eddy current sensor and the sleeper through which the sensor is to pass are updated based on the distribution data of the maglev steel rail sleepers and the distribution data of the eddy current sensors of the maglev train. One eddy current sensor is selected from the plurality of eddy current sensors in the maglev train and adopted as a positioning reference. When a next pulse is generated, a traveling distance of the maglev train between the two pulse signals is determined only by detecting a number corresponding to an eddy current sensor as a positioning reference.

In step 2), a moving time difference of the maglev train is calculated based on the pulse moments respectively corresponding to the two adjacent eddy current pulses.

In step 3), the first speed value of the maglev train is calculated based on the moving distance value of the maglev train and the moving time difference of the maglev train.

In Step 400, a second speed value of the maglev train is calculated based on a first speed value corresponding to an eddy current pulse data group of which pulse moment is ranked ahead in the two eddy current pulse data groups and in combination with acceleration sensing data.

The step 400 specifically includes the step of calculating the second speed value of the maglev train according to the following formula

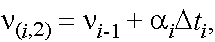

where
v_{(i,2)} represents the second speed value of the maglev train, that is, a speed value calculated by an acceleration sensor; vᵢ₋₁ represents the first speed value corresponding to an eddy current pulse data group of which pulse moment is ranked ahead in the two eddy current pulse data groups; aᵢ represents an acceleration value measured by the acceleration sensor; Δtᵢ represents a difference between the pulse moments respectively corresponding to the two eddy current pulse data groups, specifically a time difference between a pulse falling edge in an eddy current pulse data group of which pulse moment is ranked ahead in the two eddy current pulse data groups and a pulse falling edge in an eddy current pulse data group of which pulse moment is ranked behind in the two eddy current pulse data groups: and i represents a sequence of the eddy current pulse data group in the two eddy current pulse data groups.

In Step 500, a third speed value of the maglev train is calculated based on radar sensing data. An operation principle of a radar sensor based on Doppler Effect is to first transmit an ultrasonic wave to the ground, and then measure a frequency shift of a returned wave. If the frequency shift is large, a relative speed between the ultrasonic wave and the returned wave is fast. In a speed measurement process by the radar sensor, the frequency shift measured by the Doppler radar, an included angle between a radar sensor and a rail plane of the maglev train, and a radar wavelength are acquired. A third speed value of the maglev train is calculated according to a formula

$${v}_{( i , 3 )} = \frac{{f}_{i} \cdot λ}{2 cos θ} ,$$

where
v_{(i,3)} represents the third speed value of the maglev train; fi represents a frequency shift measured by a Doppler radar corresponding to an eddy current pulse data group of which pulse moment is ranked behind in the two eddy current pulse data groups; λ represents the radar wavelength; and θ represents the included angle between a radar sensor and a rail plane of the maglev train. As a running speed of the train is faster, a speed measurement result of the radar sensor is more accurate.

In Step 600, the first speed value, the second speed value, and the third speed value are fused to obtain a final speed value of the maglev train.

The step 600 specifically includes the following steps 1) to 3).

In step 1), a difference between the first speed value and the second speed value, a difference between the second speed value and the third speed value, and a difference between the third speed value and the first speed value are calculated, and their absolute values are calculated to obtain three difference values.

In step 2), if the three difference values are all smaller than a preset error value, an average of the first speed value, the second speed value, and the third speed value is calculated, to obtain the final speed value of the maglev train.

In step 3), if any two of the three difference values are larger than the preset error value, an average of two speed values corresponding to the other difference value than the any two difference values is calculated, to obtain the final speed value of the maglev train. Specifically, if one speed value is too large or too small, differences between this speed value and the other two speed values may be large, and may further be greater than the preset error value. Therefore, it is considered that the measurement is inaccurate and discarded.

In a specific application, the speed measurement method of a medium and low speed maglev train provided by this disclosure further includes Step 700.

In Step 700, it is determined whether the final speed value of the maglev train is 0. If the final speed value is not 0, the speed measurement continues. If the final speed value is 0, it is determined whether the maglev train stops. If the maglev train stops, the speed measurement ends. If the maglev train does not stop, the steps 100 to 600 are repeated to continue to measure the speed.

### Embodiment 2

Refer to FIG. 4, a speed measurement system of a medium and low speed maglev train is provided in this embodiment, to perform the method mentioned in the Embodiment 1, to achieve functions and technical effect corresponding to the method. The system includes a pulse data acquisition module 101, a sensor position determining module 201, a first speed calculation module 301, a second speed calculation module 401, a third speed calculation module 501, and a final speed calculation module 601.

The pulse data acquisition module 101 is configured to acquire two eddy current pulse data groups of the maglev train, where each of the two eddy current pulse data groups includes two adjacent eddy current pulses.

The sensor position determining module 201 is configured to determine, for each eddy current pulse in each eddy current pulse data group, a position of a marked eddy current sensor based on the eddy current pulse, distribution data of maglev steel rail sleepers, and distribution data of eddy current sensors of the maglev train, where the marked eddy current sensor is any eddy current sensor in the maglev train.

The first speed calculation module 301 is configured to determine a first speed value of the maglev train based on positions of marked eddy current sensors respectively corresponding to the two adjacent eddy current pulses and pulse moments respectively corresponding to the two adjacent eddy current pulses.

The second speed calculation module 401 is configured to calculate a second speed value of the maglev train based on a first speed value corresponding to an eddy current pulse data group of which pulse moment is ranked ahead in the two eddy current pulse data groups and in combination with acceleration sensing data.

The third speed calculation module 501 is configured to calculate a third speed value of the maglev train based on radar sensing data.

The final speed calculation module 601 is configured to fuse the first speed value, the second speed value, and the third speed value to obtain a final speed value of the maglev train.

### Embodiment 3

A speed measurement apparatus of a medium and low speed maglev train is provided in this embodiment, which includes a memory and a processor.

The memory is configured to store a computer program, and the processor is configured to run the computer program to perform the speed measurement method of a medium and low speed maglev train in the Embodiment 1.

Compared with a conventional technology, this disclosure has the following advantages.

According to this disclosure, when the speed is measured based on the distribution information of the sleepers, the position of the maglev train may be directly updated while the speed is measured, so that a positioning requirement of the maglev train can be met.

Each example of the present specification is described in a progressive manner, each example focuses on the difference from other examples, and the same and similar parts between the examples may refer to each other.

Specific examples are used herein to explain the principles and embodiments of the present disclosure. The foregoing description of the embodiments is merely intended to help understand the method of the present disclosure and core ideas thereof; besides, various modifications may be made by those of ordinary skill in the art to specific embodiments and the scope of application in accordance with the ideas of the present disclosure. In conclusion, the content of the present specification shall not be construed as limitations to the present disclosure.

1. A speed measurement method of a medium and low speed maglev train, comprising:
acquiring two eddy current pulse data groups of the maglev train, wherein each of the two eddy current pulse data groups comprises two adjacent eddy current pulses;
determining, for each eddy current pulse in each eddy current pulse data group, a position of a marked eddy current sensor based on the eddy current pulse, distribution data of maglev steel rail sleepers, and distribution data of eddy current sensors of the maglev train, wherein the marked eddy current sensor is any eddy current sensor in the maglev train;
determining, for each of the two eddy current pulse data groups, a first speed value of the maglev train based on positions of marked eddy current sensors respectively corresponding to the two adjacent eddy current pulses and pulse moments respectively corresponding to the two adjacent eddy current pulses;
calculating a second speed value of the maglev train based on a first speed value corresponding to an eddy current pulse data group of which pulse moment is ranked ahead in the two eddy current pulse data groups and in combination with acceleration sensing data measured by an acceleration sensor;
calculating, for an eddy current pulse data group of which pulse moment is ranked behind in the two eddy current pulse data groups, a third speed value of the maglev train based on radar sensing data measured by a radar sensor; and
fusing a first speed value, the second speed value, and the third speed value for the eddy current pulse data group ranked behind to obtain a final speed value of the maglev train.

2. The speed measurement method according to claim 1, wherein the distribution data of the maglev steel rail sleepers comprises sleeper number data and sleeper spacing data, and the distribution data of the eddy current sensors of the maglev train comprises sensor number data and sensor spacing data; and
the determining, for each eddy current pulse in each eddy current pulse data group, a position of a marked eddy current sensor based on the eddy current pulse, distribution data of maglev steel rail sleepers, and distribution data of eddy current sensors of the maglev train comprises:
determining, based on the eddy current pulse, the sleeper number data, and the sensor number data, a sleeper number and a sensor number corresponding to the eddy current pulse; and
determining the position of the marked eddy current sensor based on the sleeper spacing data, the sensor spacing data, a sensor number corresponding to the marked eddy current sensor, and the sleeper number and the sensor number corresponding to the eddy current pulse.

3. The speed measurement method according to claim 1, wherein the determining, for each of the two eddy current pulse data groups, a first speed value of the maglev train based on positions of marked eddy current sensors respectively corresponding to the two adjacent eddy current pulses and pulse moments respectively corresponding to the two adjacent eddy current pulses comprises:
calculating a moving distance value of the maglev train based on the positions of marked eddy current sensors respectively corresponding to the two adjacent eddy current pulses;
calculating a moving time difference of the maglev train based on the pulse moments respectively corresponding to the two adjacent eddy current pulses; and
calculating the first speed value of the maglev train based on the moving distance value of the maglev train and the moving time difference of the maglev train.

4. The speed measurement method according to claim 1, wherein the calculating a second speed value of the maglev train based on a first speed value corresponding to an eddy current pulse data group of which pulse moment is ranked ahead in the two eddy current pulse data groups and in combination with acceleration sensing data measured by an acceleration sensor comprises:
calculating the second speed value of the maglev train according to following formula 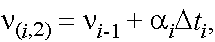
wherein
v_{(i,2)} represents the second speed value of the maglev train; vᵢ₋₁ represents the first speed value corresponding to an eddy current pulse data group of which pulse moment is ranked ahead in the two eddy current pulse data groups; aᵢ represents an acceleration value; Δtᵢ represents a difference between pulse moment respectively corresponding to the two eddy current pulse data groups; and i represents a sequence of the eddy current pulse data group in the two eddy current pulse data groups.

5. The speed measurement method according to claim 1, wherein the radar sensing data comprises a frequency shift measured by a Doppler radar, an included angle between a radar sensor and a rail plane of the maglev train, and a radar wavelength; and
the calculating, for an eddy current pulse data group of which pulse moment is ranked behind in the two eddy current pulse data groups, a third speed value of the maglev train based on radar sensing data measured by a radar sensor comprises:
calculating the third speed value of the maglev train according to following formula
$${v}_{( i , 3 )} = \frac{{f}_{i} \cdot λ}{2 cos θ} ,$$
wherein
v_{(i,3)} represents the third speed value of the maglev train; fᵢ represents a frequency shift measured by a Doppler radar corresponding to an eddy current pulse data group of which pulse moment is ranked behind in the two eddy current pulse data groups; λ represents the radar wavelength; and θ represents the included angle between a radar sensor and a rail plane of the maglev train.

6. The speed measurement method according to claim 1, wherein the fusing a first speed value, the second speed value, and the third speed value for the eddy current pulse data group ranked behind to obtain a final speed value of the maglev train comprises:
calculating a difference between the first speed value and the second speed value, a difference between the second speed value and the third speed value, and a difference between the third speed value and the first speed value, and calculating absolute values thereof to obtain three difference values;
if the three difference values are all smaller than a preset error value, calculating an average of the first speed value, the second speed value, and the third speed value, to obtain the final speed value of the maglev train; or
if any two of the three difference values are larger than the preset error value, calculating an average of two speed values corresponding to an other difference value than the any two difference values, to obtain the final speed value of the maglev train.

7. The speed measurement method according to claim 1, further comprises:
acquiring an actual number of each maglev steel rail sleeper through an on-board code reader;
acquiring, by using an eddy current sensor located at a head of the maglev train, a number of times that the train crosses sleepers;
determining, based on the number of times that the train crosses sleepers, a calculated number corresponding to the maglev steel rail sleeper which is read by the on-board code reader;
comparing the calculated number with the actual number to obtain a first result; and
if the first result indicates that the calculated number and the actual number are not consistent, generating a missing detection warning signal; or
if the first result indicates that the calculated number and the actual number are consistent, generating a data normal signal.

8. A speed measurement system of a medium and low speed maglev train, comprising:
a pulse data acquisition module, configured to acquire two eddy current pulse data groups of the maglev train, wherein each of the two eddy current pulse data groups comprises two adjacent eddy current pulses;
a sensor position determining module, configured to determine, for each eddy current pulse in each eddy current pulse data group, a position of a marked eddy current sensor based on the eddy current pulse, distribution data of maglev steel rail sleepers, and distribution data of eddy current sensors of the maglev train, wherein the marked eddy current sensor is any eddy current sensor in the maglev train;
a first speed calculation module, configured to determine, for each of the two current pulse data groups, a first speed value of the maglev train based on positions of marked eddy current sensors respectively corresponding to the two adjacent eddy current pulses and pulse moments respectively corresponding to the two adjacent eddy current pulses;
a second speed calculation module, configured to calculate a second speed value of the maglev train based on a first speed value corresponding to an eddy current pulse data group of which pulse moment is ranked ahead in the two eddy current pulse data groups and in combination with acceleration sensing data measured by an acceleration sensor;
a third speed calculation module, configured to calculate, for an eddy current pulse data group of which pulse moment is ranked behind in the two eddy current pulse data groups, a third speed value of the maglev train based on radar sensing data measured by a radar sensor; and
a final speed calculation module, configured to fuse a first speed value, the second speed value, and the third speed value for the eddy current pulse data group ranked behind to obtain a final speed value of the maglev train.

9. A speed measurement apparatus of a medium and low speed maglev train, comprising a memory and a processor, wherein
the memory is configured to store a computer program, and the processor is configured to run the computer program to perform a speed measurement method, which comprises:
acquiring two eddy current pulse data groups of the maglev train, wherein each of the two eddy current pulse data groups comprises two adjacent eddy current pulses;
determining, for each eddy current pulse in each eddy current pulse data group, a position of a marked eddy current sensor based on the eddy current pulse, distribution data of maglev steel rail sleepers, and distribution data of eddy current sensors of the maglev train, wherein the marked eddy current sensor is any eddy current sensor in the maglev train;
determining, for each of the two eddy current pulse data groups, a first speed value of the maglev train based on positions of marked eddy current sensors respectively corresponding to the two adjacent eddy current pulses and pulse moments respectively corresponding to the two adjacent eddy current pulses;
calculating a second speed value of the maglev train based on a first speed value corresponding to an eddy current pulse data group of which pulse moment is ranked ahead in the two eddy current pulse data groups and in combination with acceleration sensing data measured by an acceleration sensor;
calculating, for an eddy current pulse data group of which pulse moment is ranked behind in the two eddy current pulse data groups, a third speed value of the maglev train based on radar sensing data measured by a radar sensor; and
fusing a first speed value, the second speed value, and the third speed value for the eddy current pulse data group ranked behind to obtain a final speed value of the maglev train.

10. The speed measurement apparatus according to claim 9, wherein the distribution data of the maglev steel rail sleepers comprises sleeper number data and sleeper spacing data, and the distribution data of the eddy current sensors of the maglev train comprises sensor number data and sensor spacing data; and
the determining, for each eddy current pulse in each eddy current pulse data group, a position of a marked eddy current sensor based on the eddy current pulse, distribution data of maglev steel rail sleepers, and distribution data of eddy current sensors of the maglev train comprises:
determining, based on the eddy current pulse, the sleeper number data, and the sensor number data, a sleeper number and a sensor number corresponding to the eddy current pulse; and
determining the position of the marked eddy current sensor based on the sleeper spacing data, the sensor spacing data, a sensor number corresponding to the marked eddy current sensor, and the sleeper number and the sensor number corresponding to the eddy current pulse.

11. The speed measurement apparatus according to claim 9, wherein the determining, for each of the two eddy current pulse data groups, a first speed value of the maglev train based on positions of marked eddy current sensors respectively corresponding to the two adjacent eddy current pulses and pulse moments respectively corresponding to the two adjacent eddy current pulses comprises:
calculating a moving distance value of the maglev train based on the positions of marked eddy current sensors respectively corresponding to the two adjacent eddy current pulses;
calculating a moving time difference of the maglev train based on the pulse moments respectively corresponding to the two adjacent eddy current pulses; and
calculating the first speed value of the maglev train based on the moving distance value of the maglev train and the moving time difference of the maglev train.

12. The speed measurement apparatus according to claim 9, wherein the calculating a second speed value of the maglev train based on a first speed value corresponding to an eddy current pulse data group of which pulse moment is ranked ahead in the two eddy current pulse data groups and in combination with acceleration sensing data measured by an acceleration sensor comprises:
calculating the second speed value of the maglev train according to following formula 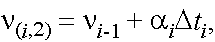
wherein
v_{(i,2)} represents the second speed value of the maglev train; vᵢ₋₁ represents the first speed value corresponding to an eddy current pulse data group of which pulse moment is ranked ahead in the two eddy current pulse data groups; aᵢ represents an acceleration value; Δtᵢ represents a difference between pulse moment respectively corresponding to the two eddy current pulse data groups; and i represents a sequence of the eddy current pulse data group in the two eddy current pulse data groups.

13. The speed measurement apparatus according to claim 9, wherein the radar sensing data comprises a frequency shift measured by a Doppler radar, an included angle between a radar sensor and a rail plane of the maglev train, and a radar wavelength; and
the calculating, for an eddy current pulse data group of which pulse moment is ranked behind in the two eddy current pulse data groups, a third speed value of the maglev train based on radar sensing data measured by a radar sensor comprises:
calculating the third speed value of the maglev train according to following formula
$${v}_{( i , 3 )} = \frac{{f}_{i} \cdot λ}{2 cos θ} ,$$
wherein
v_{(i,3)} represents the third speed value of the maglev train; fᵢ represents a frequency shift measured by a Doppler radar corresponding to an eddy current pulse data group of which pulse moment is ranked behind in the two eddy current pulse data groups; λ represents the radar wavelength; and θ represents the included angle between a radar sensor and a rail plane of the maglev train.

14. The speed measurement apparatus according to claim 9, wherein the fusing a first speed value, the second speed value, and the third speed value for the eddy current pulse data group ranked behind to obtain a final speed value of the maglev train comprises:
calculating a difference between the first speed value and the second speed value, a difference between the second speed value and the third speed value, and a difference between the third speed value and the first speed value, and calculating absolute values thereof to obtain three difference values;
if the three difference values are all smaller than a preset error value, calculating an average of the first speed value, the second speed value, and the third speed value, to obtain the final speed value of the maglev train; or
if any two of the three difference values are larger than the preset error value, calculating an average of two speed values corresponding to an other difference value than the any two difference values, to obtain the final speed value of the maglev train.

15. The speed measurement apparatus according to claim 9, further comprises:
acquiring an actual number of each maglev steel rail sleeper through an on-board code reader;
acquiring, by using an eddy current sensor located at a head of the maglev train, a number of times that the train crosses sleepers;
determining, based on the number of times that the train crosses sleepers, a calculated number corresponding to the maglev steel rail sleeper which is read by the on-board code reader;
comparing the calculated number with the actual number to obtain a first result; and
if the first result indicates that the calculated number and the actual number are not consistent, generating a missing detection warning signal; or
if the first result indicates that the calculated number and the actual number are consistent, generating a data normal signal.
